(19) United States
(12) Patent Application Publication
(10) Pub. No.: US 2003/0014338 A1
(43) Pub. Date: Jan. 16, 2003

(54) Tip-calculating device with a single tip-computation activation key

(76) Inventor: Eric Chen, Taipei (TW)

Correspondence Address: ROTHWELL, FIGG, ERNST & MANBECK, P.C., 1425 K STREET, N.W., SUITE 800, WASHINGTON, DC, 20005, US

(21) Appl. No.: 09/902,630

(22) Filed: Jul. 12, 2001

(51) Int. Cl. G06F 17/60

(52) U.S. Cl. 705/35

(57) ABSTRACT

A tip-calculating device with a single tip-computation activation key is proposed, which allows the user to quickly calculate for the amount of a tip that should be given to a service person in such places as restaurant based on the total amount of expense being charged. The proposed tip-calculating device is characterized in that, after the user completes the inputting of the total amount of expense through numeric keypad, he/she just needs to press one more key, called tip-computation activation key, to cause the tip-calculating device to display the result. Compared to the prior art, since it requires the pressing of six more keys (which include multiplication key, numeric keys for the tip rate, and equal key) after the user completes the inputting of the total amount of expense, the tip-calculating device is undoubtedly more efficient and less time-wasting than the prior art.

### BACKGROUND OF THE INVENTION

1. Field of the Invention

This invention relates to a calculating device, and more particularly, to a tip-calculating device that allows the user to quickly calculate for the amount of a tip that should be given to a service person in such places as restaurant based on the total amount of expense being charged.

2. Description of Related Art

A calculator is a small, portable electronic device that allows the user to perform basic arithmetic operations, such as summation, subtraction, multiplication, and division. It is widely used by people to calculate for the total amount of money that is to be paid or received.

In many countries, it is a custom to give a small amount of money directly to the service person, such as to a restaurant waiter or waitress, for the service being attended. Typically, the amount of tip to be given to the service person is based on a specific rate, such as 15% (or various other rates depending on local custom), of the total amount of expense being charged. For instance, assume the tip rate is 15% and the total amount of expense being charged is US$235.00, then the amount of tip to be given to the service person should be no less than 235*0.15=35.25 dollars.

When the total amount of expense is complex in number, one would typically use a calculator to calculate for the amount of tip to be given. The use of conventional calculators for this purpose, however, would be laborious and time-wasting. This drawback is illustratively depicted in the following with reference to FIG. 1.

FIG. 1 is a schematic diagram showing the front panel of a conventional calculator 100. As shown, this conventional calculator 100 includes a numeric key set 110 (0-9), an arithmetic operation key set 120(+−* /=), and a display unit 130. The internal architecture of this calculator 100 is well-known conventional technology, so description thereof will not be further detailed.

When using the calculator 100 for calculating the amount of tip to be given, the user needs first to input the total amount of the expense the numeric key set (0-9) 110, then press the multiplication key [*] in the arithmetic operation key set 120, and again use the numeric key set 110 to input the local tip rate, which is typically 15% (0.15), and finally press the equal key [=] in the arithmetic operation key set 120 to cause the calculator 100 to perform the required arithmetic operation to obtain the corresponding amount of the tip and display it on the display unit 130.

For instance, assume the total amount expense is US$235.00, the user needs first to input [235] through the numeric key set (0-9) 110, then press the multiplication key [*] in the arithmetic operation key set 120, and again use the numeric key set 110 to input [0.15], and finally press the equal key [=] in the arithmetic operation key set 120 to cause the calculator 100 to perform the arithmetic operation to obtain the corresponding amount of tip and display the result 35.25 on the display unit 130. In this case, the required key sequence is as follows:

[2] [3] [5] [*] [0] [.] [1] [5] [=]

The above key sequence shows that, after the user completes the inputting of the total amount of expense, he/she needs to press six more keys (i.e., *[0] [.] [1] [5] [=]) to cause the calculator 100 to perform the required arithmetic operation and display the result on the display unit 130, which is considered quite laborious and time-wasting for the user.

### SUMMARY OF THE INVENTION

It is therefore an objective of this invention to provide a tip-calculating device with a single tip-computation activation key that allows the user to more quickly calculate for the amount of tip to be given to a service person based on the user's total amount of expense being charged.

It is another objective of this invention to provide a tip-calculating device with a single tip-computation activation key that allows the user to activate the tip calculation procedure after the inputting of the amount of expense is completed.

In accordance with the foregoing and other objectives, the invention proposes a novel tip-calculating device with a single tip-computation activation key.

The tip-calculating device of the invention comprises: (a) a numeric keypad for user-input of the amount of expense, (b) a computation circuit, which is capable of performing a tip-computation procedure, wherein the user-input amount of the expense is multiplied by a preset tip rate to obtain the amount of the tip; (c) a tip-computation activation key, which can be pressed to activate the tip-computation unit to start the tip-computation procedure; and (d) a display unit for displaying the result of the tip-computation procedure performed by the tip-computation unit.

The tip-calculating device of the invention is characterized in that, after the user completes the inputting of the total amount of expense, he/she just needs to press one more key (i.e., the tip-computation activation key) to cause the tip-calculating device of the invention to display the result. Compared to the prior art, since it requires the pressing of six more keys after the user completes the inputting of the total amount of expense, the tip-calculating device of the invention is undoubtedly more efficient and less time-wasting than the prior art.

### BRIEF DESCRIPTION OF DRAWING

The invention can be more fully understood by reading the following detailed description of the preferred embodiments, with reference made to the accompanying drawings, wherein:

FIG. 1 (PRIOR ART) is a schematic diagram showing the front panel of a conventional calculator;

FIG. 2 is a schematic diagram of the front panel of a calculator provided with the function of the tip-calculating device of the invention;

FIG. 3 is a schematic block diagram showing the system architecture of the tip-calculating device of the invention.

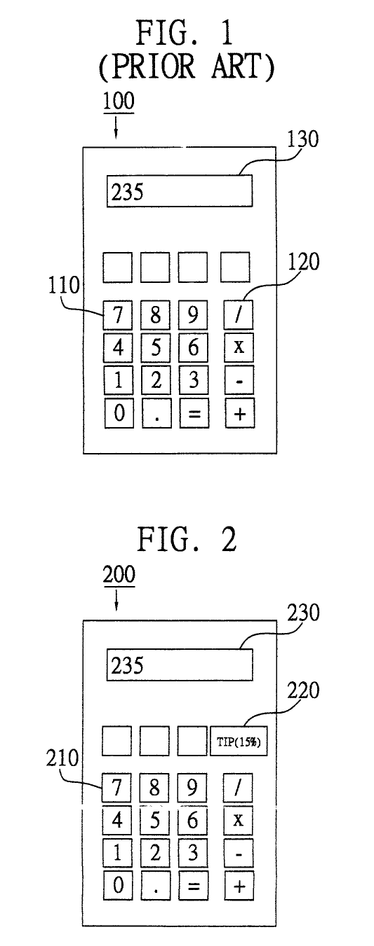

### DETAILED DESCRIPTION OF PREFERRED EMBODIMENTS

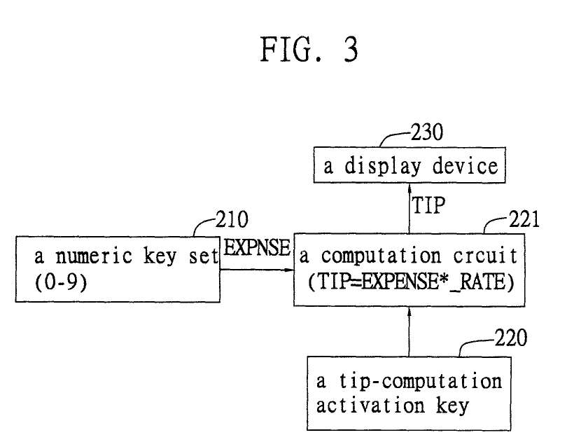

The tip-calculating device according to the invention is disclosed in full details in the following by way of preferred with reference to FIG. 2 and FIG. 3.

The tip-calculating device of the invention can be either implemented as a standalone device, or as illustrated in FIG. 2 integrated in an existing calculator 200 as an additional function to the calculator 200.

Referring to FIG. 2 together with FIG. 3, the tip-calculating device according to the invention comprises a numeric key set 210 (0-9), a tip-computation activation key 220, a computation circuit 221, and a display unit 230. The tip-computation activation key 220 is imprinted with, for example, the mark [TIP(15%)] for identification by the user.

The numeric key set (0-9) 210 allows the user to input a sequence of numbers representing the total amount of his/her expense, for example a sequence of numbers [234] representing an expense of US$235.00. The input numbers are collected as a sequence of binary data which is represented by EXPENSE. This user-input data EXPENSE is then sent directly to the computation circuit 221.

The computation circuit 221 is a special-purpose logic that is specifically designed to perform the following arithmetic operation:

TIP=EXPENSE*TIP_RATE

where

TIP represents the amount of tip to be given;

EXPENSE represents the user-input amount of expense; and

TIP_RATE is a preset constant representing the local tip rate.

In other words, the computation circuit 221 is capable of multiplying the user-input data EXPENSE by the local tip rate, for example 15%, to thereby obtain the amount of tip to be given to the service person. It is to be noted that at the time the computation circuit 221 receives the user-input data EXPENSE, the foregoing arithmetic operation will not be immediately performed until the pressing of the tip-computation activation key 220.

As the user completes the inputting of the total amount of expense through the numeric key set 210, he/she needs just to press the tip-computation activation key 220 to activate the computation circuit 221 to perform the above arithmetic operation and obtain the amount of tip to be given. The result of the arithmetic operation, represented by TIP, is directly sent to the display unit 230.

The display unit 230 is used to display the output data TIP from the computation circuit 221 which represents the amount of tip corresponding to the user-input amount of expense. The user can then give an amount of money to his/her service person based on the displayed amount of tip on the display unit 230.

In conclusion, the invention provides a tip-calculating device that allows the user to calculate for the amount of tip that should be given to his/her service person based on the total amount of expense being charged. The tip-calculating device of the invention is characterized in that, after the user completes the inputting of the total amount of expense, he/she just needs to press one more key (i.e., the tip-computation activation key 220) to cause the tip-calculating device of the invention to display the result.

In the case of the expense being US$235.00, the required key sequence is as follows:

[2] [3] [5] [TIP(15%)]

i.e., after completing the inputting of the total amount of expense, the user needs just to press one more key, i.e., the [TIP(15%)] key, to cause the tip-calculating device of the invention to display the result.

Compared to the prior art, since it requires the pressing of six more keys after the user completes the inputting of the total amount of expense, the tip-calculating device of the invention is undoubtedly more efficient and less time-wasting than the prior art.

The invention has been described using exemplary preferred embodiments. However, it is to be understood that the scope of the invention is not limited to the disclosed embodiment. On the contrary, it is intended to cover various modifications and similar arrangements. The scope of the claims, therefore, should be accorded the broadest interpretation so as to encompass all such modifications and similar arrangements.

What is claimed is:

1. A tip-calculating device for calculating the amount of a tip based on the amount of an expense being charged, which comprises:
(a) a numeric keypad for user-input of the amount of expense;
(b) a computation circuit, which is capable of performing a tip-computation procedure, wherein the user-input amount of the expense is multiplied by a preset tip rate to obtain the amount of the tip;
(c) a tip-computation activation key, which can be pressed to activate the tip-computation unit to start the tip-computation procedure; and
(d) a display unit for displaying the result of the tip-computation procedure performed by the tip-computation unit.

2. The tip-calculating device of claim 1, wherein the preset tip rate is within the range from 0% to 100%.

3. The tip-calculating device of claim 2, wherein the preset tip rate is 15%.

4. A tip-calculating device for calculating the amount of a tip based on the amount of an expense being charged, which comprises:
(a) a numeric keypad for user-input of the amount of expense;
(b) a tip-computation unit, which is capable of performing a tip-computation procedure, wherein the user-input amount of the expense is multiplied by a preset tip rate of 15% to obtain the amount of the tip;
(c) a tip-computation activation key, which can be pressed to activate the tip-computation unit to start the tip-computation procedure; and
(d) a display unit for displaying the result of the tip-computation performed by the tip-computation unit.
